(19) United States
(12) Patent Application Publication
(10) Pub. No.: US 2026/0292162 A1
(43) Pub. Date: Sep. 24, 2026

(54) METHOD OF ENCODING/DECODING FOR PERFORMING MACHINE VISION TASK AND COMPUTER READABLE RECORDING MEDIUM STORING INSTRUCTIONS FOR IMPLEMENTING ENCODING METHOD

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: Se Yoon JEONG, Daejeon (KR); Youn Hee KIM, Daejeon (KR); JooYoung LEE, Daejeon (KR); Jung Won KANG, Daejeon (KR); Seongbae Rhee, Yongin-si (KR); Kyu Heon KIM, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/576,105

(22) Filed: Mar. 24, 2026

(30) Foreign Application Priority Data
Mar. 24, 2025 (KR) 10-2025-0037600

(51) Int. Cl. H04N 19/117; H04N 19/167; H04N 19/172; H04N 19/196; H04N 19/86

(52) U.S. Cl. CPC H04N 19/117; H04N 19/167; H04N 19/172; H04N 19/196; H04N 19/86

(57) ABSTRACT

According to a method of decoding an image to perform a machine vision task in the present disclosure, the method comprising determining whether to apply a post-processing filter to a reconstructed image; in response to a determination of the post-processing filter being applied to the reconstructed image, deriving an adjustment standard deviation of the reconstructed image; and modifying the reconstructed image using the adjustment standard deviation.

### BACKGROUND OF THE INVENTION

### Field of the Invention

The present disclosure relates to an image encoding/decoding method and device for performing a machine vision task.

### Description of the Related Art

Conventionally, video encoding/decoding technology has improved video compression efficiency and image quality by considering the human visual system. However, future video encoding/decoding technology is expected to be widely used not only for human vision but also in machine vision fields such as surveillance, intelligent transportation, smart cities, and intelligent industry.

Accordingly, there is a need to develop video encoding/decoding technology by which high-efficiency compression and recognition accuracy can be obtained by simultaneously considering human vision and machine vision.

### SUMMARY OF THE INVENTION

It is an object of the present disclosure to improve machine vision task performance by clearly distinguishing between a region of interest and a background region by applying a post-processing filter that increases the contrast value of the region of interest in a reconstructed image.

It is a further object of the present disclosure to provide a method for adaptively determining whether to apply a post-processing filter based on the proportion occupied by the region of interest within a reconstructed image.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of decoding an image to perform a machine vision task, the method comprising determining whether to apply a post-processing filter to a reconstructed image; in response to a determination of the post-processing filter being applied to the reconstructed image, deriving an adjustment standard deviation of the reconstructed image; and modifying the reconstructed image using the adjustment standard deviation.

In the method of decoding an image to perform a machine vision task according to the present disclosure, whether to apply the post-processing filter to the reconstructed image is determined based on information decoded from a bitstream.

In the method of decoding an image to perform a machine vision task according to the present disclosure, the information represents a 1-bit flag signaled in units of images.

In the method of decoding an image to perform a machine vision task according to the present disclosure, whether to apply the post-processing filter to the reconstructed image is determined by comparing a ratio between a size of the reconstructed image and a size of region of interest in the reconstructed image with a threshold value.

In the method of decoding an image to perform a machine vision task according to the present disclosure, the post-processing filter is applied to the reconstructed image only when the ratio is not greater than the threshold value.

In the method of decoding an image to perform a machine vision task according to the present disclosure, the adjustment standard deviation is determined based on a result derived by comparing a ratio between a mean value of samples in the reconstructed image and a standard deviation of the samples in the reconstructed image with a threshold value.

In the method of decoding an image to perform a machine vision task according to the present disclosure, when the ratio is greater than the threshold value, the adjustment standard deviation is derived by dividing the mean value into a difference between the ratio and a contrast adjustment parameter.

In the method of decoding an image to perform a machine vision task according to the present disclosure, the contrast adjustment parameter is derived by subtracting a reference ratio from the ratio.

In the method of decoding an image to perform a machine vision task according to the present disclosure, when the ratio is not greater than the threshold value, the adjustment standard deviation is set equal to the standard deviation.

In the method of decoding an image to perform a machine vision task according to the present disclosure, a modified sample value in the reconstructed image is obtained by adding the mean value to a value obtained by applying a weight to a difference value between a sample value in the reconstructed image and the mean value.

In the method of decoding an image to perform a machine vision task according to the present disclosure, the weight represents a ratio between the adjustment standard deviation and the standard deviation.

In the method of decoding an image to perform a machine vision task according to the present disclosure, a modification is applied only to a luma component of the reconstructed image.

In the method of decoding an image to perform a machine vision task according to the present disclosure, the reconstructed image is obtained by scaling the luma component.

Meanwhile, in the present disclosure, it is possible to provide a computer-readable recording medium recording instructions for implementing the method of decoding an image to perform a machine vision task.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of a video encoder according to an embodiment of the present disclosure.

FIG. 2 is a block diagram of a video decoder according to an embodiment of the present disclosure.

FIG. 3 illustrates an example in which ROI-based processing is performed.

FIG. 4 is a flowchart of the process of restoring an image in an image decoder.

FIG. 5 is a flowchart of a method for applying a post-processing filter according to an embodiment of the present disclosure.

### DETAILED DESCRIPTION OF THE INVENTION

As the present disclosure may make various changes and have multiple embodiments, specific embodiments are illustrated in a drawing and are described in detail in a detailed description. But it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The present disclosure proposes a pair of image encoder and image decoder for video encoding/decoding for machines. The pair of image encoder and image decoder described in the present disclosure may support machine consumption or hybrid machine-human consumption. Here, human consumption refers to normal human video watching, and machine consumption refers to machine tasks performed through video. Examples of machine tasks include object classification, object recognition, object detection, object segmentation, object tracking, super resolution, or frame interpolation.

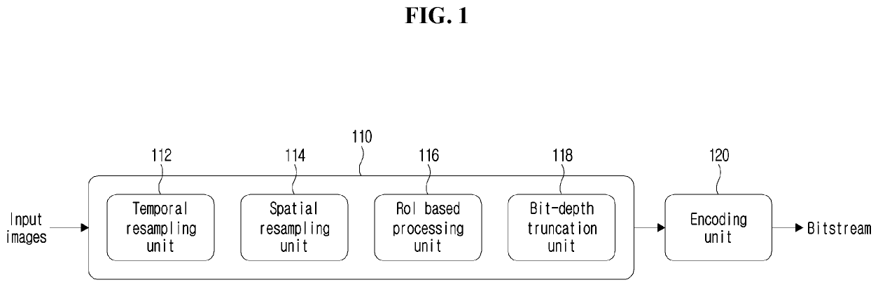

FIG. 1 is a block diagram of a video encoder according to an embodiment of the present disclosure.

Referring to FIG. 1, the video encoder may include a preprocessing unit 110 and an image encoding unit 120.

The preprocessing unit 110 performs a preprocessing process to convert input original images into images suitable for image encoding. Here, images input to the preprocessor 110 may be color or black-and-white images conforming to the YUV, RGB or YCbCr format.

The preprocessing unit 110 may include at least one of a temporal resampling unit 112, a spatial resampling unit 114, a RoI (region-of-interest)-based processing unit 116 or bit-depth truncation unit 118.

The temporal resampling unit 112 temporally resamples images. Only resampled images may be selected for image encoding. That is, encoding of some of the images input to the preprocessor 110 may be omitted through temporal resampling. For example, a 60 fps (frame per second) video may be converted into a 30 fps video by omitting odd-numbered images of the 60 fps video. Alternatively, images in a specific output order may be omitted by considering temporal redundancy between images.

The temporal resampling may be performed in units of sequences or sub-sequences.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The spatial resampling may be performed in units of sequences or sub-sequences.

The RoI-based processing unit 116 sets a region of interest in an image such that image encoding/decoding is performed focusing on information important to machine inference tasks. The region-of-interest-based processing unit 116 may remove a background region excluding the set region of interest or adjust the size and/or location of the region of interest in the image, so that the region of interest is set to be encoded/decoded with high quality. Here, removing the background region may involve filling the background region with a specific value.

The bit-depth truncation unit 118 performs bit depth truncation on the input image. Specifically, by performing a right-shifting operation on the input image, the amount of bits to be encoded may be reduced.

Meanwhile, the bit depth truncation may be performed on at least one of the color components.

For example, if a YUV format image is input, a 1-bit right-shifting operation may be performed only on the Y component.

The image encoding unit 120 encodes the image output from the preprocessing unit 110. Meanwhile, the image encoding unit 120 may encode the image using conventional codec technology or a codec technology modified based on the conventional codec technology for VCM (Video Coding for Machine). As an example, the image encoding unit 120 may encode the image based on HEVC, VVC, or AV1. As a result of image encoding, a bitstream is generated and the generated bitstream may be transmitted to a video decoder.

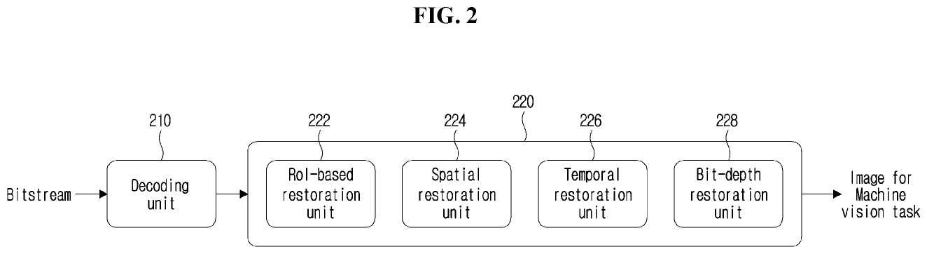

FIG. 2 is a block diagram of a video decoder according to an embodiment of the present disclosure.

Referring to FIG. 2, the video decoder may include an image decoding unit 210 and a post-processing unit 220.

The image decoding unit 210 decodes a bitstream received from the video encoding unit 110 to generate a decoded or reconstructed image. The image decoding unit 210 may decode the bitstream based on the codec technology used in the image encoding unit 120.

The post-processing unit 220 performs post-processing on the decoded image.

Through post-processing, the size and frame rate of the images may be restored to match the original images.

The post-processing unit 220 may include at least one of a RoI-based reconstruction unit 222, a spatial reconstruction unit 224, a temporal reconstruction unit 226 or a bit-depth reconstruction unit 228.

The RoI-based reconstruction unit 222 obtains an image of the same size as an original image based on RoI information. For example, when a cropped image is encoded such that a region of interest is included therein, the decoded image has a different size from the original image. Accordingly, the RoI-based reconstruction unit 222 may adjust the retargeted image to the original size. Here, the retargeted image may represent a decoded image or an image on which upscaling has been performed through the spatial reconstruction unit 224. Alternatively, when the size or position of a region of interest in an encoding target image has been adjusted, the RoI-based reconstruction unit 222 may adjust the position and size of the region of interest in the retargeted image to match the original image.

The spatial reconstruction unit 224 performs upscaling on a decoded image. The decoded image may be reconstructed to be an image having the same size and/or spatial resolution as the original image through upscaling.

The temporal reconstruction unit 226 reconstructs an image at a temporal position where encoding/decoding has been omitted through temporal resampling. Specifically, the temporal reconstruction unit 226 may generate an image at a temporal position where encoding/decoding has been omitted through interpolation between decoded images.

The bit-depth reconstruction unit 228 restores the bit-depth of the input image to its original bit-depth. Specifically, by performing a left-shifting operation on the input image, the bit-depth of the input image may be restored to the original bit-depth.

Meanwhile, bit restoration may be performed on at least one of the color components.

For example, if a YUV format image is input, a 1-bit left-shifting operation may be performed only on the Y component.

Meanwhile, in order to perform reverse processing on the image processing performed in the preprocessor 110, additional information may be encoded and signaled. The post-processor 220 may perform post-processing on decoded images based on the additional information to generate images for machine inference. The additional information may be referred to as “metadata”.

Metadata may include at least one of temporal resampling information, spatial resampling information, or region-of-interest processing information.

The temporal resampling information may include at least one of a flag indicating whether temporal resampling has been performed or information indicating a temporal resampling rate.

For example, the flag indicates that temporal resampling has been performed when set to 1. In this case, information indicating a temporal resampling rate may be additionally encoded/decoded. When temporal resampling is performed, fewer images than the number of original images may be encoded/decoded. The video decoder can reconstruct images for which encoding/decoding has been omitted through temporal reconstruction.

On the other hand, the flag indicates that temporal resampling has not been performed when set to 0.

The temporal resampling rate may be represented as an exponent of 2. For example, a temporal resampling rate of 2\hat{ }N indicates that one of 2\hat{ }N images is selected as an encoding/decoding target image. For example, only images having a picture order count (POC) of a multiple of 2\hat{ }N can be encoded/decoded. Information representing the temporal resampling rate may represent the exponent (i.e., N) of the temporal resampling rate. As an example, the information may represent the exponent value of the temporal resampling rate or the value obtained by subtracting 1 from the exponent value.

The spatial resampling information may include at least one of a flag indicating whether spatial resampling has been performed or information indicating a scaling parameter for spatial resampling.

As an example, the flag indicates that spatial resampling has been performed when set to 1. In this case, information representing a scaling parameter may be additionally encoded. Specifically, information representing a horizontal scaling parameter and information representing a vertical scaling parameter may be encoded, respectively, and the encoded information may be signaled. When spatial resampling is performed, the size and/or spatial resolution of an image may be reduced. The video decoder may restore the size of a decoded image to the size of the original image or a pre-defined size, through spatial reconstruction. Meanwhile, information, indicating the pre-defined size, may be further encoded/decoded.

The flag indicates that spatial resampling has not been performed when set to 0.

The region-of-interest processing information may include at least one of image size information or region-of-interest information.

The image size information may include information indicating whether retargeting has been performed. If the retargeting flag is 1, it indicates that the retargeted image is encoded/decoded instead of the original image. On the other hand, if the retargeting flag is 0, it indicates that the original image is encoded/decoded as is.

The retargeted image indicates an image generated by performing at least one of resolution adjustment and position adjustment on at least one region of interest in the original image. Accordingly, the resolution or position of the region of interest in the retargeted image may be different from that of the original image. In addition, the size of the retargeted image may be the same as or smaller than that of the original image.

When retargeting is allowed (i.e., if the retargeting flag is 1), the size information of the retargeted image may be encoded/decoded. The size information of the retargeted image may include width information of the image and height information of the image.

Meanwhile, information indicating the size difference between the original image and the retargeted image may be additionally encoded/decoded. For example, information indicating whether a size difference between the size of the retargeted image and the size of the original image is encoded/decoded or not may be encoded/decoded.

For example, when the information, indicating whether the size difference is encoded/decoded or not, is 0, it indicates that the size difference between the retargeted image and the original image is not encoded/decoded.

On the other hand, when the information, indicating whether the size difference is encoded/decoded or not, is 1, it indicates that the size difference between the retargeted image and the original image is encoded/decoded. In this case, information indicating the size difference between the size of the retargeted image and the size of the original image may be additionally encoded/decoded.

The information representing the size difference indicates the size difference between the original image and the retargeted image. Information representing the size difference in the horizontal direction and information representing a size difference in the vertical direction may be encoded and signaled, respectively.

The region-of-interest information may include at least one of a flag indicating whether a region of interest is present, information on the number of regions of interest, a scaling parameter of a region of interest, or position information of a region of interest.

For example, when the flag is 1, it indicates that information on a region of interest may be encoded/decoded. In this case, at least one of the number of regions of interest, scaling parameter information of a region of interest, position information of a region of interest, or size information of a region of interest may be additionally encoded/decoded.

On the other hand, when the flag is 0, it indicates that a region of interest is not present.

The information on the number of regions of interest indicates the number of regions of interest. Meanwhile, the number of regions of interest may be calculated in units of image groups including at least one image.

A scaling parameter of a region of interest represents the scaling parameter with respect to the region of interest. Depending on the scaling parameter of the region of interest, the size of the region of interest may be adjusted.

Scaling parameter information of a region of interest may include information indicating whether the scaling parameter of the region of interest is updated. If the information, indicating whether the region of interest is updated or not, indicates that the scaling parameter of the region of interest will not be updated, the scaling parameter of the region of interest may be set to a default value or the same value as in the previous frame. On the other hand, when the information, indicating whether the region of interest is updated or not, indicates that the scaling parameter of the region of interest needs to be updated, the information indicating the scaling parameter of the region of interest may be additionally encoded/decoded.

Meanwhile, scaling parameter information of a region of interest may be encoded/decoded individually for each region of interest.

Position information of a region of interest indicates the position of the region of interest in the original image. The horizontal position (i.e., x-axis coordinate) information and vertical position (i.e., y-axis coordinate) information of the region of interest may be encoded/decoded.

Size information of a region of interest indicates the size of the region of interest in the original image. The horizontal size (i.e., width) information and the vertical size (i.e., height) information of the region of interest may be encoded/decoded.

As described above, an image encoder may perform RoI (Region-of-Interest) based processing by distinguishing a ROI and a background region within an image and then filling the background region with a specific value.

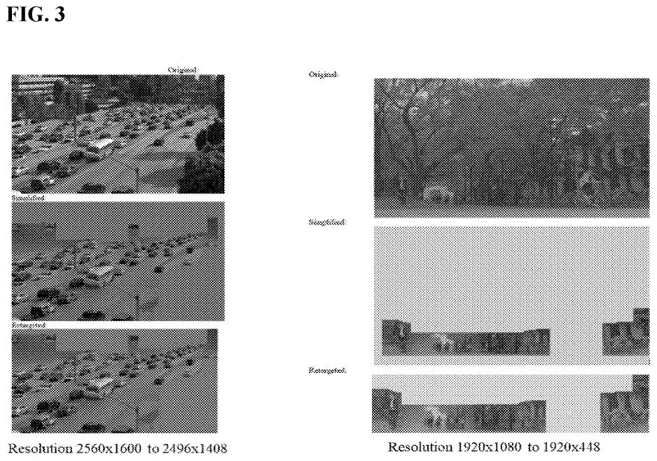

FIG. 3 illustrates an example in which ROI-based processing is performed.

However, as shown in the example on a right side of FIG. 3, if the size of the RoI is excessively small compared to the overall size of the image, the brightness contrast between the object within the ROI and the background may decrease. That is, if the background region occupies a large proportion of the image, the specific value used to fill the background region represents as the main component of the image, which degrades the quality of distinction between the object and the background, resulting in a decrease in object detection accuracy.

To resolve this problem, the present disclosure proposes a method for applying a post-processing filter to maintain machine task performance. Specifically, the post-processing filter proposed in the present disclosure may be intended to enhance the contrast value of the RoI to clearly distinguish the boundary between the RoI and the background region.

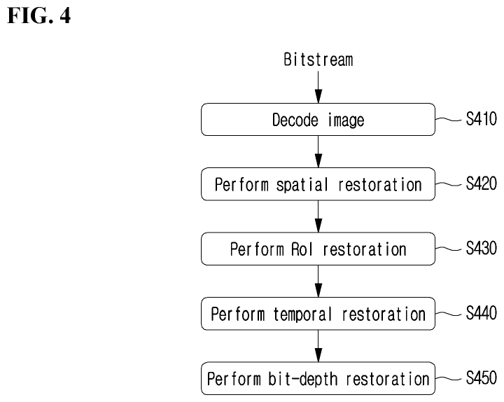

FIG. 4 is a flowchart of the process of restoring an image in an image decoder.

As shown in the example illustrated in FIG. 4, the image decoder may decode images from a bitstream S410 and perform spatial restoration on the decoded images S420. Spatial restoration may involve performing upscaling on an image with reduced resolution. Through upscaling, the image with reduced resolution may be restored to the size of the retargeted image or the original image.

Subsequently, RoI restoration may be performed on the upscaled images S430. RoI restoration may involve restoring an image of original size from the upscaled image, in which the size and location of RoIs are restored to their original size and location.

Once the images of original size are restored, temporal restoration may be performed to generate an image at the output point (i.e., POC, Picture Order Count) where encoding/decoding is omitted S440. The image at the output point, where encoding/decoding is omitted, may be generated by interpolating the restored images of their original size.

Subsequently, bit depth restoration may be performed on the restored images S450. Bit depth restoration may represent the process of restoring the bit depth of the image to its original bit depth.

The post-processing filter proposed in the present disclosure may be used as part of a bit depth restoration process.

Alternatively, applying the post-processing filter proposed in the present disclosure may be defined to be performed after the bit depth restoration process has been performed. For example, in the bit depth restoration process, the bit depth of the luminance component is restored by scaling (i.e., left shifting operation) the luminance component sample values. The post-processing filter described in the present disclosure may be performed on the scaled luminance component sample values.

Alternatively, applying the post-processing filter proposed in the present disclosure may be defined to be performed immediately before the bit depth restoration process. That is, after applying the post-processing filter to the restored image, the bit depth of the luminance component may be restored by scaling the luminance component sample values of the filtered restored image.

Meanwhile, the post-processing filter may be applied only to the luminance component. For example, if the restored image is a 3-channel image of YUV format, the post-processing filter may be applied only to the Y component. Alternatively, the post-processing filter may be configured to be applied to the chroma component as well as the luminance component.

Alternatively, if the reconstructed image is a 3-channel image of RGB format, the post-processing filter may be configured to be applied to each of the RGB channels.

For convenience of explanation, in the embodiments described below, it is assumed that the post-processing filter is applied only to the luminance component (i.e., the Y component) within the reconstructed image.

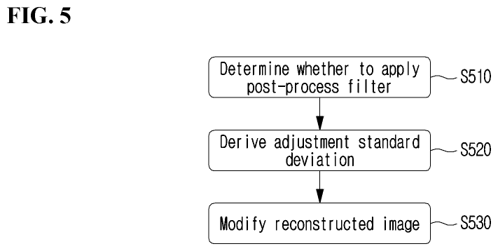

FIG. 5 is a flowchart of a method for applying a post-processing filter according to an embodiment of the present disclosure.

An image decoder may determine whether to apply a post-processing filter to a restored image S510. Here, the restored image may represent at least one of an image restored through spatial restoration, an image restored through RoI restoration, or an image generated through temporal restoration.

Information indicating whether to apply a post-processing filter may be encoded and signaled. The information may be encoded and signaled at the sequence level or the picture level. Based on the information, the image decoder may determine whether to apply a post-processing filter to the restored image.

Table 1 shows a syntax structure including information indicating whether to apply a post-processing filter as described in the present disclosure.

TABLE 1

| | Descriptor |
|---|---|
| bit_depth_shift( ) { | |
| bit_depth_shift_flag | u(1) |
| if( bit_depth_shift_flag ) { | |
| bit_depth_shift_luma | u(3) |
| bit_depth_shift_chroma | u(3) |
| } | |
| bit_depth_luma_contrast_enhance | u(1) |
| byte_alignment( ) | |
| } | |

In Table 1, the syntax bit_depth_luma_contrast_enhance may indicate whether to apply a post-processing filter to the reconstructed image. For example, a value of 1 for the syntax bit_depth_luma_contrast_enhance indicates that a post-processing filter should be applied to the reconstructed image. Conversely, a value of 0 for the syntax bit_depth_luma_contrast_enhance indicates that no post-processing filter is applied to the reconstructed image.

Meanwhile, the syntax bit_depth_luma_contrast_enhance may be affected to all images within a sequence that refers to the corresponding syntax structure.

Unlike the example in Table 1, information indicating whether to apply a post-processing filter may be encoded and signaled for each image.

Table 2 shows an example where information indicating whether to apply a post-processing filter is encoded and signaled in units of images.

TABLE 2

| | Descriptor |
|---|---|
| adaptive_contrast_enhance ( payloadSize ) { | |
| bit_depth_luma_contrast_enhance | u(1) |
| if(! bit_depth_luma_contrast_enhance ) { | |
| nriq_num_input_pics | ue(v) |
| for (i=0; i < nriq_num_input_pics; i++) { | |
| bit_depth_luma_contrast_enhance_flag[ i ] | u(1) |
| } | |
| } | |
| } | |

In Table 2, the syntax bit_depth_luma_contrast_enhance indicates whether a post-processing filter is applied to the images included in the sequence. A value of 1 for the syntax bit_depth_luma_contrast_enhance indicates that a post-processing filter is applied to all images in the sequence. Conversely, a value of 0 for the syntax bit_depth_luma_contrast_enhance indicates that the application of a post-processing filter is determined in units of images.

When the value of the syntax bit_depth_luma_contrast_enhance is 0, the syntax bit_depth_luma_contrast_enhance_flag[i] may be encoded and signaled in units of images.

The syntax bit_depth_luma_contrast_enhance_flag[i] may indicate whether a post-processing filter is applied to the image with index i. For example, a syntax bit_depth_luma_contrast_enhance_flag[i] of 1 indicates that a post-processing filter is applied to the image with index i. Conversely, a syntax bit_depth_luma_contrast_enhance_flag[i] of 0 indicates that no post-processing filter is applied to the image with index i.

As shown in the example in Table 2, the syntax bit_depth_luma_contrast_enhance_flag may be encoded and signaled for each of the images.

Alternatively, the syntax bit_depth_luma_contrast_enhance_flag may be encoded and signaled only for the first frame of the GoP (Group of Pictures).

As another example, whether to apply a post-processing filter may be adaptively determined based on the proportion of the RoI in the entire region in the image. For example, without encoding/decoding the syntax bit_depth_luma_contrast_enhance_flag, whether to apply a post-processing filter may be determined based on whether the proportion of the RoI in the entire region in the image is greater than a threshold value. Specifically, if the proportion of the RoI in the image is greater than the threshold value, it may be determined not to apply the post-processing filter. That is, the value of the syntax bit_depth_luma_contrast_enhance_flag may be inferred to be 0. On the other hand, if the proportion of the RoI in the image is not greater than the threshold value, it may be determined to apply the post-processing filter. That is, the value of the syntax bit_depth_luma_contrast_enhance_flag may be inferred to be 1.

When it is determined to apply a post-processing filter, an adjustment standard deviation may be derived to enhance the contrast of the reconstructed image S520.

The adjustment standard deviation may be derived using at least one of the average value or the standard deviation of the samples included in the reconstructed image.

Specifically, when it is determined to apply a post-processing filter, the ratio between the average value μ_{y} and the standard deviation σ_{y} for the luminance component (i.e., the Y component) in the reconstructed image in YUV format may be calculated. For example, the ratio ratio_{cur} between the average value μ_{y} and the standard deviation σ_{y} of the luminance samples may be obtained based on the following equation 1.

$${ratio}_{cur} = \frac{{μ}_{y}}{{σ}_{y} + ϵ} \qquad [ Equation 1 ]$$

Here, ε may be set as a constant value. For example, ε may have an integer value including 0.

By comparing the ratio ratio_{cur} with the threshold θₗ, the adjustment standard deviation σᵣₑᵥ may be derived. For example, the adjustment standard deviation σᵣₑᵥ may be derived according to the following Equation 2.

$${σ}_{rev} = \{ \begin{matrix}\frac{{μ}_{y}}{{ratio}_{cur} - {val}_{c}} , & if {ratio}_{cur} > {θ}_{l} \\ {σ}_{y} , & otherwise\end{matrix} \qquad [ Equation 2 ]$$

As exemplified in Equation 2 above, when the ratio ratio_{cur} is greater than the threshold θₗ, the adjustment standard deviation σᵣₑᵥ may be derived by dividing the average value μ_{y} of the luminance component by the difference between the ratio ratio_{cur} and the contrast adjustment parameter val_{c}.

On the other hand, when the ratio ratio_{cur} is not greater than the threshold θₗ, the adjustment standard deviation σᵣₑᵥ may be set to be equal to the standard deviation σ_{y} of the luminance component.

The threshold θₗ may be predefined in the encoder and decoder.

Alternatively, information for determining the threshold θₗ may be encoded and signaled. This information may be an index indicating one of a plurality of threshold candidate values. Furthermore, this information may be encoded and signaled only when bit_depth_luma_contrast_enhance is 1.

Meanwhile, the contrast adjustment parameter val_{c} may be derived according to the following Equation 3.

$${val}_{c} = min ( max ( {ratio}_{cur} - {S}_{p} , {V}_{min} ) , {V}_{max} ) \qquad [ Equation 3 ]$$

In Equation 3, the variable Sₚ represents the reference ratio, and Vₘᵢₙ and Vₘₐₓ represent the minimum and maximum adjustment values, respectively. That is, the contrast adjustment parameter val_{c} may be set to a value within the range of Vₘᵢₙ and Vₘₐₓ. For example, if the difference between the ratio ratio_{cur} and the reference ratio Sₚ exists within the adjustment range, the contrast adjustment parameter val, may be set to the difference between the ratio ratio_{cur} and the reference ratio Sₚ. Conversely, if the difference between the ratio ratio_{cur} and the reference ratio Sₚ is greater than the maximum value Vₘₐₓ of the adjustment range, the contrast adjustment parameter vale can be set to the maximum value Vₘₐₓ of the adjustment range. Conversely, if the difference between the ratio ratio_{cur} and the reference ratio Sₚ is smaller than the minimum value Vₘᵢₙ of the adjustment range, the contrast adjustment parameter val_{c} may be set to the minimum value Vₘᵢₙ of the adjustment range.

The reference ratio Sₚ may be predefined in the encoder and decoder. Alternatively, information indicating the reference ratio Sₚ may be encoded and signaled. Alternatively, a reference ratio Sₚ may be derived based on a threshold value θₗ. For example, the reference ratio Sₚ may be derived by adding a predetermined value (e.g., 1) to the threshold value θₗ.

Similarly, the minimum adjustment value Vₘᵢₙ and the maximum adjustment value Vₘₐₓ may be predefined in the encoder and decoder. Alternatively, information for determining at least one of the minimum adjustment value Vₘᵢₙ and the maximum adjustment value Vₘₐₓ may be encoded and signaled. Alternatively, the minimum adjustment value Vₘᵢₙ and the maximum adjustment value Vₘₐₓ may be derived based on a threshold value θₗ. For example, the minimum adjustment value Vₘᵢₙ may be derived by subtracting a predetermined value M from the threshold value θₗ, and the maximum adjustment value Vₘₐₓ may be derived by subtracting a predetermined value N from the threshold value θₗ. Here, M may be an integer greater than N. For example, M may be 5 and N may be 2.

The adjustment standard deviation may also be derived using a reconstructed image to which a predefined filter was applied. For example, a morphological filter may be applied to the reconstructed image to clearly define the boundary between the RoI and the background region, and then the adjustment standard deviation σᵣₑᵥ may be derived using the mean value μ_{y} and standard deviation σ_{y} of the samples in the reconstructed image to which the morphological filter was applied.

On the other hand, unlike the example in Equation 2, if the ratio ratio_{cur} is not greater than the threshold θₗ, it may be determined not to apply the post-processing filter. That is, if the ratio ratio_{cur} is not greater than the threshold θₗ, the sample values in the reconstructed image may not be modified.

Alternatively, an adjustment standard deviation may be derived based on the ratio between the size of the ROI(s) in the reconstructed image and the size of the background region in the reconstructed image. For example, if the ratio between the RoI(s) and the background region is greater than the threshold value, the adjustment standard deviation σᵣₑᵥ is derived using the contrast adjustment parameter val_{c} as shown in the top of Equation 2, and otherwise, the adjustment standard deviation σᵣₑᵥ is derived without using the contrast adjustment parameter val, as shown in the bottom of Equation 2.

Based on the adjustment standard deviation σᵣₑᵥ, the values of the samples in the reconstructed image may be modified (or refined) S530. For example, the value of the luminance sample in the reconstructed image may be modified according to the following Equation 4.

$${Y}_{rev} = ( Y - {μ}_{y} ) * \frac{{σ}_{rev}}{{σ}_{y} + ϵ} + {μ}_{y} \qquad [ Equation 4 ]$$

In Equation 4, Y represents the value of a luminance sample in the reconstructed image, and Yᵣₑᵥ represents the value of a modified luminance sample. As in the example of Equation 4, the modified luminance sample Yᵣₑᵥ may be obtained by summing the value derived by multiplying the difference between the luminance sample Y and the mean value μ_{y} by a weight to the mean value μ_{y}. Here, the weight may represent the ratio between the adjustment standard deviation σᵣₑᵥ and the standard deviation σ_{y} (or the value obtained by summing the offset ε to the standard deviation σ_{y}).

As described above, the post-processing filter may be applied only to the luminance component.

If the post-processing filter proposed in this disclosure is to be applied to the chroma component as well, the filter may be applied to the chroma component by substituting the sample values for the luminance component with the sample values for the chroma component in Equations 1 to 3. That is, the chroma component samples may be modified by substituting the average value μ_{y}, standard deviation σ_{y}, and sample value Y of the luminance component sample with the average value μ_{c}, standard deviation σ_{c}, and sample value C of the chroma component sample in Equations 1 to 4.

Meanwhile, the post-processing filter proposed in this disclosure may be applied after applying CLAHE (Contrast Limited Adaptive Histogram Equalization) to the scaled luminance component image. In this case, CLAHE is applied by default without considering the ratio of the RoI, whereas the application of the post-processing filter may be determined adaptively by considering the ratio of the RoI.

Specifically, when bit_depth_luma_contrast_enhance is 1, luminance samples may be modified based on CLAHE, and then the post-processing filter proposed in this disclosure may be selectively applied to the modified luminance samples. For example, after obtaining luminance samples modified based on CLAHE, it may be determined whether to re-modify the modified luminance samples based on the post-processing filter proposed in this disclosure based on whether the ratio between the mean value and the standard deviation of the modified luminance samples is greater than a threshold value. That is, modification of the luminance sample illustrated in FIG. 4 may represent a re-modification of the modified luminance samples.

Only when the ratio is greater than a threshold value, the luminance samples may be re-modified based on the post-processing filter proposed in this disclosure.

Meanwhile, CLAHE may modify the luminance sample based on a lookup table. Specifically, to modify the luminance sample, a lookup table may be derived using a histogram distribution. In this case, the histogram may be generated in units of tiles. For example, the current picture may be divided into a plurality of tiles, and a lookup table may be derived for each tile.

A histogram may be derived based on the samples within the tile. The size of the histogram may be equal to the range that can be expressed according to the bit-depth. For example, in the case of a 10-bit image, the histogram may represent the number of samples corresponding to each sample value from 0 to 1023.

Meanwhile, the maximum number of samples corresponding to each sample value in the histogram may be limited to a threshold value so that it does not exceed the threshold value. Here, the threshold value may be determined based on a size of the tile and a size of the histogram.

If the number of samples corresponding to a specific sample value within a tile is greater than a threshold value, the number of samples corresponding to that specific sample value on the histogram may be set as the threshold value. Additionally, the remaining number of samples not reflected in the histogram may be evenly distributed on the histogram.

Based on the histogram, an output sample value corresponding to each sample value may be determined. For example, a cumulative number of samples may be derived according to an ascending order of the sample values, and an output sample value corresponding to an existing sample value may be determined based on the cumulative number of samples.

The cumulative number of samples for a specific sample value may be the sum of the number of samples for the specific sample value and sample values smaller than the specific sample value. For example, the cumulative number of samples for sample value v may be the cumulative number of samples corresponding from sample value α to sample value v.

The cumulative number of samples normalized by the number of pixels within the tile may be set as the output sample value. Based on the above principle, a lookup table may be generated that defines the mapping relationship between input sample values and output sample values.

Subsequently, based on the lookup table, a modified value of the luminance sample may be obtained. That is, the output sample value corresponding to the luminance sample value in the lookup table may be output as the modified value of the luminance sample.

As the lookup table is generated in units of tiles, artifacts may occur at the boundary between tiles. Accordingly, a filter may be applied at the boundary between tiles. The filter may be an interpolation filter that interpolates the reconstructed samples located at the boundary between the two tiles.

According to the present disclosure, by applying a post-processing filter that increases the contrast of a region of interest in a reconstructed image, the distinction between the region of interest and the background region is clarified, thereby improving machine vision task performance.

According to the present disclosure, by adaptively determining whether to apply a post-processing filter based on the proportion occupied by the region of interest in the reconstructed image, the effect of improving encoding/decoding efficiency is achieved.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding an image for performing machine vision task, comprising:
determining whether to apply a post-processing filter to a reconstructed image;
in response to a determination of the post-processing filter being applied to the reconstructed image, deriving an adjustment standard deviation of the reconstructed image; and
modifying the reconstructed image using the adjustment standard deviation.

2. The method of claim 1, wherein whether to apply the post-processing filter to the reconstructed image is determined based on information decoded from a bitstream.

3. The method of claim 2, wherein the information represents a 1-bit flag signaled in units of images.

4. The method of claim 1, wherein whether to apply the post-processing filter to the reconstructed image is determined by comparing a ratio between a size of the reconstructed image and a size of region of interest in the reconstructed image with a threshold value.

5. The method of claim 4, wherein the post-processing filter is applied to the reconstructed image only when the ratio is not greater than the threshold value.

6. The method of claim 1, wherein the adjustment standard deviation is determined based on a result derived by comparing a ratio between a mean value of samples in the reconstructed image and a standard deviation of the samples in the reconstructed image with a threshold value.

7. The method of claim 6, wherein when the ratio is greater than the threshold value, the adjustment standard deviation is derived by dividing the mean value into a difference between the ratio and a contrast adjustment parameter.

8. The method of claim 7, wherein the contrast adjustment parameter is derived by subtracting a reference ratio from the ratio.

9. The method of claim 7, wherein when the ratio is not greater than the threshold value, the adjustment standard deviation is set equal to the standard deviation.

10. The method of claim 6, wherein a modified sample value in the reconstructed image is obtained by adding the mean value to a value obtained by applying a weighted to a difference value between a sample value in the reconstructed image and the mean value.

11. The method of claim 10, wherein the weight represents a ratio between the adjustment standard deviation and the standard deviation.

12. The method of claim 1, wherein a modification is applied only to a luma component of the reconstructed image.

13. The method of claim 12, wherein the reconstructed image is obtained by scaling the luma component.

14. A non-transitory computer readable medium storing instructions when executed cause the computer to carry out:
determining whether to apply a post-processing filter to a reconstructed image;
in response to a determination of the post-processing filter being applied to the reconstructed image, deriving an adjustment standard deviation of the reconstructed image; and
modifying the reconstructed image using the adjustment standard deviation.
